(19) United States
(12) Patent Application Publication
(10) Pub. No.: US 2025/0272054 A1
(43) Pub. Date: Aug. 28, 2025

(54) AUDIO PLAYBACK METHOD AND APPARATUS, COMPUTER READABLE STORAGE MEDIUM, AND ELECTRONIC DEVICE

(71) Applicant: XG TECH PTE. LTD., Singapore (SG)

(72) Inventor: Guangwei CHENG, Singapore (SG)

(73) Assignee: XG TECH PTE. LTD., Singapore (SG)

(21) Appl. No.: 19/209,227

(22) Filed: May 15, 2025

(30) Foreign Application Priority Data
Jun. 27, 2024 (CN) 202410850818.6

(51) Int. Cl. G06F 3/16; H04S 7/00

(52) U.S. Cl. CPC G06F 3/165; H04S 7/303; H04S 2400/11; H04S 2400/13; H04S 2400/15

(57) ABSTRACT

Disclosed in embodiments of the present disclosure are an audio playback method and apparatus, a computer readable storage medium, and an electronic device. The method includes: determining ambient noise information corresponding to a first audio signal, where the first audio signal is obtained by performing audio acquisition for a target space; acquiring listening position information for the target space; and playing, based on the ambient noise information and the listening position information, a second audio signal. In the embodiments of the present disclosure, ambient noise information for a target space may be sensed in real time, and a volume at which an audio signal is played in the target space may be dynamically adjusted according to the ambient noise information.

### CROSS-REFERENCE TO RELATED APPLICATION

The present disclosure claims priority to Chinese Patent Application No. 2024108508186 filed on Jun. 27, 2024, which is incorporated herein by reference in its entirety.

### TECHNICAL FIELD

The present disclosure relates to audio technologies, and in particular, to an audio playback method and apparatus, a computer readable storage medium, and an electronic device.

### BACKGROUND

At present, in some specific spaces (such as inside vehicles), sounds emitted by certain individuals or within certain areas may be captured and played back. For example, in a scenario where a user sings inside a vehicle, sounds acquired by microphone devices equipped in the vehicle as sound pickup terminals may be played back through loudspeakers after noise reduction processing.

### SUMMARY

Embodiments of the present disclosure provide an audio playback method, apparatus, computer-readable storage medium, and electronic device, to dynamically adjust the volume for playing audio signal according to ambient noise information for a target space and thus improve listening experience of a user.

According to a first aspect of the embodiments of the present disclosure, there is provided an audio playback method, including: determining ambient noise information corresponding to a first audio signal, where the first audio signal is obtained by performing audio acquisition for a target space; acquiring listening position information for the target space; and playing, based on the ambient noise information and the listening position information, a second audio signal.

According to a second aspect of the embodiments of the present disclosure, there is provided an audio playback apparatus, including: a determination module, configured to determine ambient noise information corresponding to a first audio signal, where the first audio signal is obtained by performing audio acquisition for a target space; a first acquisition module, configured to acquire listening position information for the target space; and a playback module, configured to play, based on the ambient noise information and the listening position information, a second audio signal.

According to a third aspect of the embodiments of the present disclosure, there is provided a non-transitory computer-readable storage medium, on which a computer program is stored, where the computer program, when executed by a processor, causes the processor to implement the audio playback method described above.

According to a fourth aspect of the embodiments of the present disclosure, there is provided an electronic device, including: a processor; and a memory configured to store instructions executable by the processor, where the processor is configured to read the executable instructions from the memory and execute the instructions to implement the audio playback method described above.

Based on the audio playback method and apparatus, the computer readable storage medium, and the electronic device provided in the embodiments of the present disclosure, ambient noise information is determined according to a first audio signal obtained by performing audio acquisition for a target space, and thus a second audio signal may be played according to listening position information and the ambient noise information for the target space. In the technical solution of the present disclosure, ambient noise information for the target space may be sensed in real time, and a volume at which an audio signal is played for the target space may be dynamically adjusted according to the ambient noise information, thereby achieving timeliness and accuracy in volume adjustment for the target space. In addition, playing the audio signal with reference to the listening position information may achieve targeted adjustment of the playback volume of the audio signal according to a listening position of each user within the target space, thereby further improving listening experience of the users.

The technical solutions of the present disclosure are further described in detail below through accompanying drawings and embodiments.

### BRIEF DESCRIPTION OF DRAWINGS

The foregoing and other objectives, features, and advantages of the present disclosure will become more apparent by describing the embodiments of the present disclosure in greater detail with reference to the accompanying drawings. The accompanying drawings are intended to provide further understanding of the embodiments of the present disclosure and constitute part of the specification. They are used together with the embodiments of the present disclosure to explain the present disclosure but do not limit the present disclosure. In the accompanying drawings, the same reference signs typically represent the same components or steps.

FIG. 1 is a diagram of a system to which the present disclosure is applicable;

FIG. 2 is a schematic flowchart illustrating an audio playback method according to an exemplary embodiment of the present disclosure;

FIG. 3 is a schematic flowchart illustrating determining of an audio playback signal in each of the sound zones according to an exemplary embodiment of the present disclosure;

FIG. 4 is a schematic diagram illustrating an application scenario of an audio playback method according to an embodiment of the present disclosure;

FIG. 5 is a schematic flowchart illustrating determining of ambient noise information according to an exemplary embodiment of the present disclosure;

FIG. 6 is a schematic flowchart illustrating determining of ambient noise information according to another exemplary embodiment of the present disclosure;

FIG. 7 is a schematic flowchart illustrating an audio playback method according to another exemplary embodiment of the present disclosure;

FIG. 8 is a schematic flowchart illustrating an audio playback method according to another exemplary embodiment of the present disclosure;

FIG. 9 is a schematic flowchart illustrating determining of a target playback volume according to an exemplary embodiment of the present disclosure;

FIG. 10 is a schematic diagram illustrating a structure of an audio playback apparatus according to an exemplary embodiment of the present disclosure;

FIG. 11 is a schematic diagram illustrating a structure of an audio playback apparatus according to another exemplary embodiment of the present disclosure; and

FIG. 12 is a diagram illustrating a structure of an electronic device according to an exemplary embodiment of the present disclosure.

### DETAILED DESCRIPTION OF THE EMBODIMENTS

To explain the present disclosure, exemplary embodiments of the present disclosure will be described in detail below with reference to the accompanying drawings. Apparently, the described embodiments are merely some, not all, of embodiments of the present disclosure. It should be understood that the present disclosure is not limited by the exemplary embodiments.

It should be noted that the relative arrangement of components and steps, numerical expressions, and numerical values set forth in these embodiments do not limit the scope of the present disclosure, unless otherwise specifically stated.

### Overview of the Present Disclosure

At present, in an audio playback solution, an audio signal is output typically at a fixed volume or at a volume a user manually adjusts, failing to dynamically adjust a playback volume of an audio signal according to ambient noise in a target space. In addition, it is also impossible to automatically adjust the playback volume based on a change in a listening position caused by movement of the user in the target space, resulting in inflexible and unintelligent volume adjustments. In the technical solutions of the present disclosure, an audio signal may be acquired for a target space, ambient noise information is determined according to the acquired audio signal, and then a volume at which a second audio signal is played is automatically adjusted according to listening position information and the ambient noise information for the target space, thereby achieving timeliness and accuracy in volume adjustment for the target space.

### Exemplary System

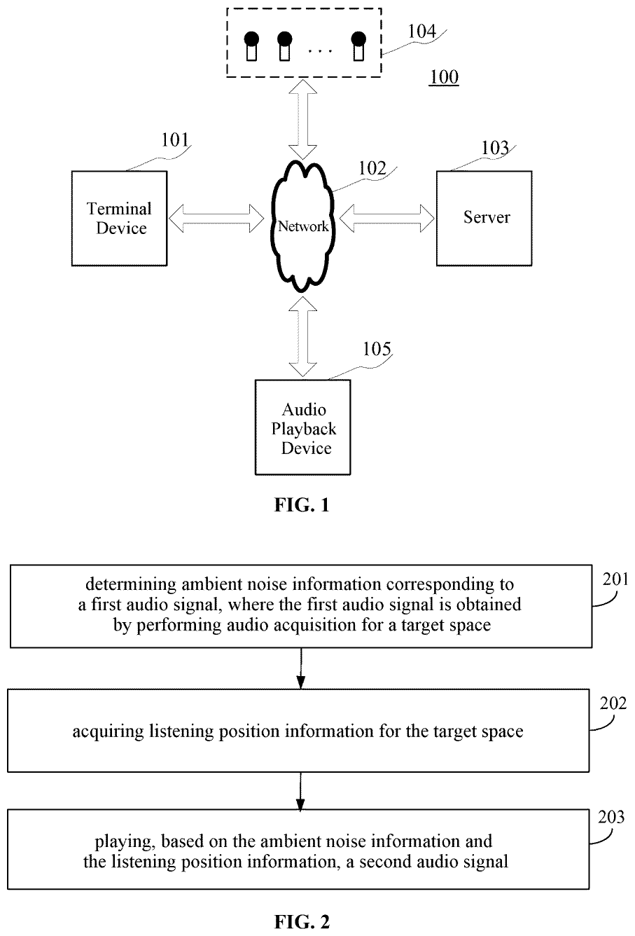

FIG. 1 illustrates an exemplary system architecture 100 to which an audio playback method or an audio playback apparatus of the embodiments of the present disclosure may be applied.

As shown in FIG. 1, the system architecture 100 may include a terminal device 101, a network 102, a server 103, a microphone array 104, and an audio playback device 105. The network 102 serves as a medium providing a communication link between the terminal device 101 and the server 103. The network 102 may include various connection types, such as wired or wireless communication links or fiber optic cables.

The microphone array 104 may acquire an audio signal emitted in a target space. The audio playback device 105 may play the audio signal acquired by the microphone array 104, or may play an audio signal provided by other sound sources.

A user may use the terminal device 101 to interact with the server 103 through the network 102 to receive or send a message or the like. Various communication client applications such as multimedia applications, search applications, web browser applications, shopping applications, and instant messaging tools may be installed on the terminal device 101.

The terminal device 101 may be various electronic devices capable of audio playing, including but not limited to mobile terminals such as in-vehicle terminals, mobile phones, laptops, digital broadcast receivers, PDA (personal digital assistants), PAD (tablet), PMPs (portable or PMP (portable multimedia players), and fixed terminals such as digital TVs, desktop computers, and smart home appliances.

The server 103 may be a server that provides various services, for example, a background server that processes an audio signal uploaded by the terminal device 101. The background server may perform processing such as separation and sound zone determination on at least one received audio signal to obtain a processing result (for example, an audio signal corresponding to an audio playback sound zone).

It should be noted that, the audio playback method provided in the embodiments of the present disclosure may be executed by the server 103 or the terminal device 101. Correspondingly, the audio playback apparatus may be disposed in the server 103 or the terminal device 101.

It should be understood that, numbers of terminal devices 101, networks 102, servers 103, microphone arrays 104, and audio playback devices 105 in FIG. 1 are merely illustrative. There may be any number of terminal devices 101, networks 102, servers 103, microphone arrays 104, and audio playback devices 105 depending on implementation needs. For example, in the case that remote audio signal processing is not required, the foregoing system architecture may not include a network and a server, but include only a microphone array, a terminal device, and an audio playback device.

### Exemplary Method

FIG. 2 is a schematic flowchart illustrating an audio playback method according to an exemplary embodiment of the present disclosure. This embodiment may be applied to an electronic device, such as a server or an in-vehicle computing platform, and as shown in FIG. 2, includes the following steps:

Step 201: determining ambient noise information corresponding to a first audio signal, where the first audio signal is obtained by performing audio acquisition for a target space.

The target space may be various spaces, such as an interior space of a vehicle and an interior space of a room. The first audio signal may be a signal obtained by performing audio acquisition for the target space. The first audio signal may include a noise signal, such as an engine sound, or may include a non-noise signal, such as a voice signal or an audio signal played by an audio playback device. The ambient noise information may be ambient noise energy, which may be calculated based on the strength and frequency of the noise signal.

In this embodiment, the electronic device may acquire the first audio signal acquired by a microphone array for the target space, implement noise reduction by using a neural network technology, acquire a noise signal in the first audio signal during the noise reduction process, and then determine ambient noise information (ambient noise energy) of the target space by using information such as the strength and frequency of the noise signal.

Step 202: acquiring listening position information for the target space.

The listening position information may be ear position information of a user within the target space. A listening position varies with different sitting postures of the user. For example, a listening position when the user leans against a back of a seat is different from a listening position when the user leans forward.

Different listening position information may correspond to different signal gain values. Therefore, in this embodiment, the listening position information for the target space may be acquired in real time, and a volume at which an audio signal is subsequently played may be determined with reference to the listening position information.

Step 203: playing, based on the ambient noise information and the listening position information, a second audio signal.

In a scenario, the second audio signal may be an audio signal that needs to be played back. For example, when a passenger in a vehicle wants to sing karaoke, an audio signal including a sound signal of the passenger singing a song and a noise signal may be acquired through a microphone, and then, according to ambient noise energy corresponding to the noise signal and listening position information of a user listening to the song, an audio playback device may be controlled to automatically adjust a volume at which audio of singing the song is played back.

In another scenario, the second audio signal may alternatively be music to be played. For example, a user may control the audio playback device to play audio from a preset audio library. During the playback of the audio, an audio signal within the target space may be acquired in real time, ambient noise energy may be determined in real time according to a noise signal in the acquired audio signal, and the audio playback device may be controlled to automatically adjust a volume at which the second audio signal is played.

It may be understood that a signal-to-noise ratio range for comfortable listening varies with different noise environments. For example, if noise is 40 dBA, the signal-to-noise ratio range for comfortable listening may be (10 dB, 15 dB). If noise is 60 dBA, the signal-to-noise ratio range for comfortable listening may be (5 dB, 8 dB). In addition, a signal gain values also vary according to different listening positions within the target space. Therefore, in this embodiment, it is helpful for improving listening experience of a user in different environments to play the second audio signal with reference to the ambient noise information and the listening position information.

According to the method provided in the foregoing embodiment of the present disclosure, ambient noise information may be determined according to a first audio signal obtained by performing audio acquisition for a target space, and thus a second audio signal may be played according to listening position information and the ambient noise information for the target space. In the technical solution of the present disclosure, ambient noise information of a target space may be sensed in real time, and a volume at which an audio signal is played within the target space may be dynamically adjusted according to the ambient noise information, thereby achieving timeliness and accuracy in volume adjustment for the target space. In addition, playing the audio signal with reference to the listening position information may achieve targeted adjustment of the playback volume of the audio signal according to a listening position of each user in the target space, thereby further improving listening experience of the users.

In some optional examples, when determining the listening position information through step 202, an image or a video acquired for the target space may be acquired; and then ear position information of a user for each of the sound zones within the target space may be determined based on the image or the video.

During specific implementation, an image may be acquired for the target space through an image acquisition device, such as a camera, disposed in the target space, and the acquired image is input into a pre-trained neural network model, and the ear position information of the user is outputted through the neural network model ear.

In some other embodiments, video information may be acquired for the target space through an image acquisition device, such as a camera, disposed in the target space, and at least one frame of image is acquired from the acquired video information. The acquired image is input into a pre-trained neural network model, and the ear position information of the user is outputted through the neural network model.

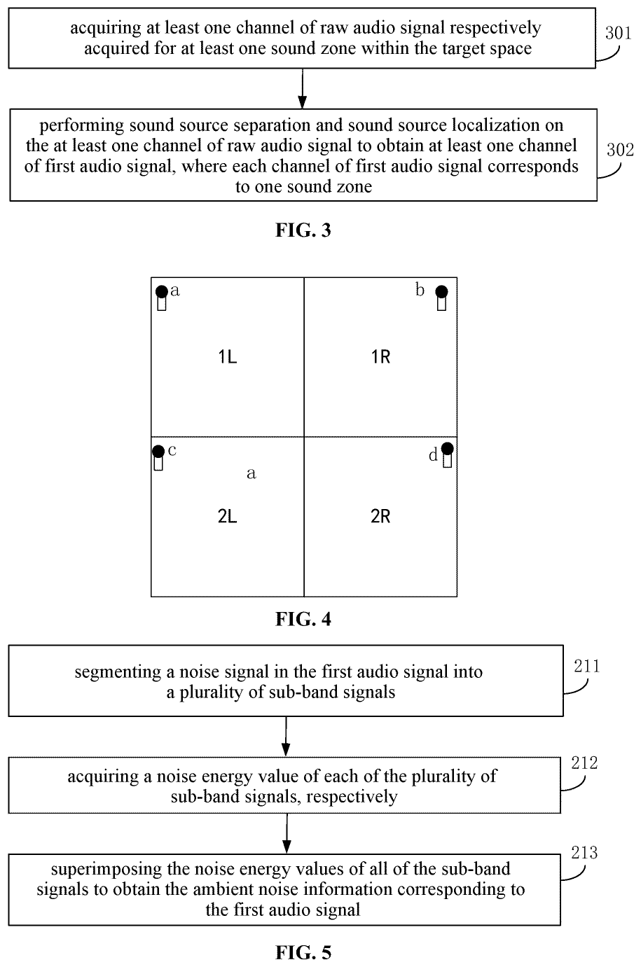

In some optional implementations, audio signals may be respectively acquired for the respective sound zones within the target space, and ambient noise information of the respective sound zones may be determined. As shown in FIG. 3, based on the foregoing embodiment shown in FIG. 2, before Step 201, a first audio signal of each of the sound zones may also be acquired through the following steps:

Step 301: acquiring at least one channel of raw audio signal respectively acquired for at least one sound zone within the target space.

The sound zone may be a plurality of zones obtained by artificially dividing the target space. For example, when the target space is an interior space of a vehicle, the sound zones may be spaces where a driver seat, a front passenger seat, and rear seats on two sides are located, respectively. As shown in FIG. 4, the spaces where the four seats are located may be classified into corresponding sound zones, including 1L, 1R, 2L, and 2R, where 1L indicates a sound zone corresponding to the driver seat, 1R indicates a sound zone corresponding to the front passenger seat, 2L indicates a sound zone corresponding to a left seat of a second row, and 2R indicates a sound zone corresponding to a right seat of the second row.

In this embodiment, the electronic device may obtain at least one channel of raw audio signal acquired by a preset microphone array. During specific implementation, each microphone in the microphone array may respectively acquire one channel of raw audio signal. For example, referring to FIG. 4, when the target space is an interior space of a vehicle, microphones a, b, c, and d are respectively disposed beside four seats, that is, the microphones a, b, c, and d respectively acquire audio signals of the four sound zones 1L, 1R, 2L, and 2R.

Step 302: performing sound source separation and sound source localization on the at least one channel of raw audio signal to obtain at least one channel of first audio signal, where each channel of first audio signal corresponds to one sound zone.

In this embodiment, the electronic device may perform signal separation on at least one channel of raw audio signal by using a sound source separation algorithm, such as a blind source separation technology, to obtain at least one channel of first audio signal.

After the at least one channel of raw audio signal is separated by using the sound source separation algorithm, the sound zones respectively corresponding to the respective channels of first audio signals may be further determined by using a sound source localization algorithm. Specifically, each channel of first audio signal may be matched with each channel of raw audio signal to determine the sound zone corresponding to each channel of first audio signal.

In an example, a similarity between each channel of first audio signal and each channel of raw audio signal may be determined, and an raw audio signal with the highest similarity to each separated first audio signal is determined. According to a microphone corresponding to the determined raw audio signal, a sound zone of the separated first audio signal may be determined.

According to the method provided in the foregoing embodiment of the present disclosure, a first audio signal for each of the sound zones may be acquired by performing sound source separation and sound source localization on at least one channel of raw audio signal acquired by a microphone array, helping to determine ambient noise information of each of the sound zones according to the first audio signal of each of the sound zones and to allow targeted adjustment of a playback volume of an audio signal in each of the sound zones, thereby further improving listening experience of users in different sound zones.

As shown in FIG. 5, based on the foregoing embodiment shown in FIG. 2, Step 201 includes the following steps:

Step 211: segmenting a noise signal in the first audio signal into a plurality of sub-band signals.

The sub-band signals refer to a plurality of sub-bands into which the noise signal is divided in frequency domain.

In this embodiment, noise reduction processing may be performed on the first audio signal by using a neural network technology, and a noise signal and a non-noise signal are output in the process of noise reduction. Then, the noise signal is divided into a plurality of sub-band signals according to a preset segmentation rule. The preset segmentation rule may indicate a number of sub-bands to be obtained through division. For example, the preset segmentation rule is to divide the noise signal into five sub-bands evenly according to a frequency range. The preset segment rule may also indicate a frequency range of each sub-band.

In this embodiment, a Fast Fourier Transform (FFT) algorithm may be used to obtain the sub-band signals, or sub-band filtering algorithms may also be used to obtain the sub-band signal.

Step 212: acquiring a noise energy value of each of the plurality of sub-band signals, respectively.

An energy value of a sub-band signal refers to signal energy within the frequency range covered by the sub-band in the frequency domain.

In this embodiment, the energy of each sub-band signal may be determined according to the square of a signal amplitude value of each sub-band signal.

Step 213: superimposing the noise energy values of all of the sub-band signals to obtain the ambient noise information corresponding to the first audio signal.

The noise energy values of all of the sub-band signals may be directly summed to obtain noise energy of the noise signal, i.e., the ambient noise information.

According to the method provided in the foregoing embodiment of the present disclosure, a noise signal is segmented into a plurality of sub-bands and each sub-band is analyzed independently, so that signal energy of each sub-band is acquired, and energy of the noise signal in different frequency ranges may be understood more clearly, thereby helping fine-tune a sub-band of a second audio signal subsequently according to energy of each sub-band signal.

Based on the foregoing embodiment shown in FIG. 5, the ambient noise information is determined according to the acquired first audio signal. To better adjust the playback volume of the audio signal, tracking and smoothing processing may be further performed on the ambient noise information determined according to the first audio signal.

As shown in FIG. 6, based on the foregoing embodiment shown in FIG. 2, after being determined according to the currently acquired first audio signal, the ambient noise information may be further smoothed through the following steps, so that when the playback volume is adjusted according to the ambient noise information, the volume may change smoothly.

Step 601: determining, based on the first audio signal, a smoothing weight for the ambient noise information.

The smoothing weight is a weight value for performing smoothing process on the ambient noise information. The weight value may be a preset fixed value, or a value dynamically determined according to signal strength of the non-noise signal and signal strength of the noise signal in the first audio signal.

In some optional implementations, during noise reduction processing of the first audio signal by using a neural network and outputting of a non-noise signal and a noise signal, the smoothing weight may be determined according to signal strength of the non-noise signal and signal strength of the noise signal.

It may be understood that, if the signal strength of the non-noise signal in the first audio signal is relatively high, ambient noise energy of the noise signal obtained through noise reduction by using the neural network may have a relatively large deviation. Therefore, a weight of the ambient noise information determined according to the first audio signal may be set to a relatively small value. The value of the weight may be a fixed value, for example, 0.2. Alternatively, the value of the weight may be dynamically adjusted according to a ratio between the signal strength of the non-noise signal and the signal strength of the noise signal in the first audio signal, to reduce the weight of the ambient noise information to be estimated relying on the noise signal in the first audio signal. If the signal strength of the non-noise signal in the first audio signal is relatively low, ambient noise energy of the noise signal obtained through noise reduction by using the neural network may have a relatively small deviation. Therefore, a weight of the ambient noise information determined according to the first audio signal may be set to a relatively large value. The value of the weight may be a fixed value, for example, 0.8. Alternatively, the value of the weight may be dynamically adjusted according to a ratio between the signal strength of the non-noise signal and the signal strength of the noise signal in the first audio signal.

In this embodiment, the value of the weight of the ambient noise information determined according to the first audio signal has an inverse proportional relationship with the ratio between the signal strength of the non-noise signal and the signal strength of the noise signal, where a larger ratio between the signal strength of the non-noise signal and the signal strength of the noise signal indicates a smaller value of the weight.

During specific implementation, a mapping relationship between the smoothing weight and the strength ratio between the non-noise signal and the noise signal may be preset. In this way, after the non-noise signal and the noise signal are determined based on the first audio signal, the smoothing weight may be obtained according to the strength ratio between the non-noise signal and the noise signal.

Step 602: performing, based on the smoothing weight, smoothing process on the ambient noise information corresponding to the first audio signal, and determine smoothed ambient noise information as the ambient noise information corresponding to the first audio signal.

During specific implementation, the ambient noise information may be smoothed in a manner from low frequency to high frequency to reduce an impact of residual voice (the non-noise signal). In some other implementations, the ambient noise information may alternatively be smoothed in a manner from high frequency to low frequency.

According to the method provided in the foregoing embodiment of the present disclosure, the ambient noise information determined based on the first audio signal is smoothed with reference to the strength of the non-noise signal and the strength of the noise signal in the first audio signal, so that an impact of the non-noise signal on the ambient noise information may be reduced, thereby helping achieve a smooth change in the playback volume when the volume is adjusted according to the ambient noise information.

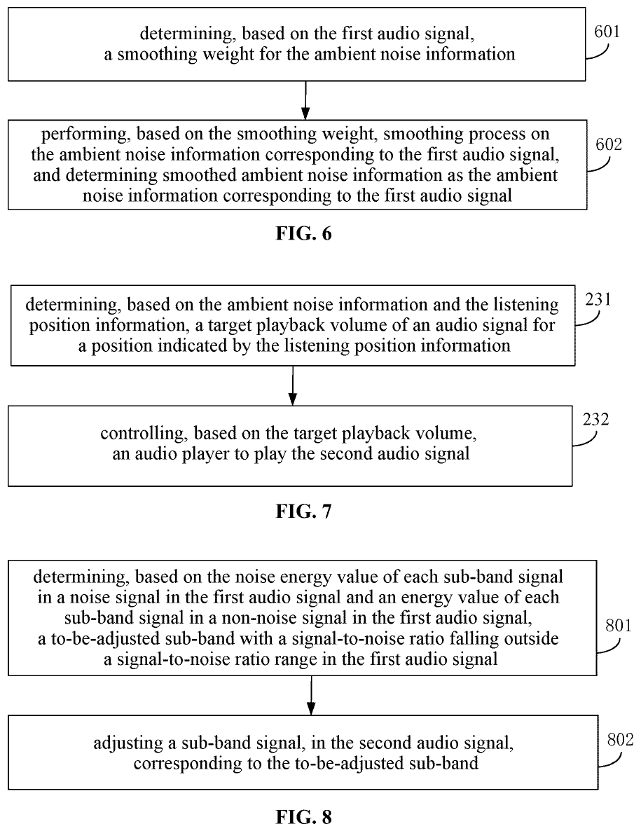

As shown in FIG. 7, based on the foregoing embodiment shown in FIG. 2, Step 203 includes the following steps:

Step 231: determining, based on the ambient noise information and the listening position information, a target playback volume of an audio signal for a position indicated by the listening position information.

The target playback volume is used for indicating energy of an audio signal outputted from an audio player. A corresponding signal-to-noise ratio range for comfortable listening varies with different noise environments.

Typically, lower noise indicates a larger signal-to-noise ratio for comfortable listening. For example, if noise is 40 dBA, the signal-to-noise ratio range may be (10 dB, 15 dB). Higher noise indicates a smaller signal-to-noise ratio for comfortable listening. For example, if noise is 60 dBA, the signal-to-noise ratio range may be (5 dB, 8 dB).

In this embodiment, a to-be-tested audio signal may be played in advance for an actual target space, such as an actual vehicle hardware system, and signal-to-noise ratio ranges corresponding to different noise environments may be evaluated to generate a signal-to-noise ratio table for the target space. The signal-to-noise ratio table may record a signal-to-noise ratio range corresponding to each physical sound pressure.

In this way, after ambient noise information corresponding to an audio signal acquired by each microphone is determined, a physical sound pressure corresponding to the ambient noise information may be determined according to the ambient noise information and a sound pressure mapping coefficient of the microphone. Moreover, a signal-to-noise ratio range corresponding to the physical sound pressure may be determined by looking up the signal-to-noise ratio table.

The sound pressure mapping coefficient of the microphone may also be obtained according to a pre-test. For example, an audio signal of 1 kHz is played in each of the sound zones of the target space, and a standard sound pressure meter is placed at the microphone. The sound pressure mapping coefficient of the microphone may be obtained by comparing signal digital energy acquired by the microphone and a value of the sound pressure meter.

In this embodiment, a signal gain table may also be pre-generated based on a to-be-tested audio signal played within the target space. A signal gain value of at least one position in each of the sound zones is recorded in the signal gain table. Different listening positions correspond to different signal gain values. Therefore, signal gain values of various positions in the vehicle may be evaluated in advance for each actual vehicle hardware system. An audio player may be disposed in each of the different sound zones in the target space. For example, as shown in FIG. 4, four sound zones in which the four seats are located each may be provided with an audio player. Therefore, a signal gain value of each position in each of the sound zones may be evaluated separately for each audio player, to improve accuracy of the signal gain value determined based on each piece of listening position information.

In some optional implementations, during the determining, based on the ambient noise information and the listening position information, of the target playback volume of the audio signal for the position indicated by the listening position information, first, a signal-to-noise ratio range matching the ambient noise information may be determined from a signal-to-noise ratio table and a signal gain value matching the listening position information may be determined from a signal gain table, and then the target playback volume of the audio signal for the position indicated by the listening position information is determined based on the signal-to-noise ratio range and the signal gain value.

During specific implementation, the signal-to-noise ratio range corresponding to the ambient noise information may be determined first, and an initial volume range for playing the audio signal is determined according to the signal-to-noise ratio range. Then, according to the signal gain value corresponding to the listening position information, the initial volume range is increased by the signal gain value to obtain a volume range within which the target playback volume falls. A volume in the volume range within which the target playback volume falls may be randomly determined as the target playback volume, or an intermediate value of the volume range into which the target playback volume falls may be determined as the target playback volume.

It should be noted that, to avoid acoustic feedback in an audio playback scenario, a volume at which an audio player plays an audio signal needs to be controlled not to be too high. Therefore, real vehicle evaluation and measurement may be further performed for a target space, such as an interior space of a vehicle, to obtain a maximum playback gain of each audio player. Moreover, during adjustment of the playback volume of the audio player in the audio playback scenario, it needs to be ensured that the target playback volume is not higher than the maximum playback gain. If a value of the determined target playback volume exceeds the maximum playback gain, a volume corresponding to the maximum playback gain may be determined as the target playback volume.

Step 232: controlling, based on the target playback volume, an audio player to play the second audio signal.

The audio player is an audio player corresponding to the position indicated by the listening position information. If the position indicated by the listening position information is a position above the driver seat, the audio player may be an audio player in a driver sound zone.

According to the method provided in the foregoing embodiment of the present disclosure, disclosed is a specific implementation of determining the target playback volume according to the ambient noise information and the listening position information, where the signal gain table and the signal-to-noise ratio table are evaluated in advance, thereby helping dynamically adjust the playback volume for the target space subsequently according to the ambient noise information and the listening position information.

To further improve quality of played audio, after the target playback volume is determined through the embodiment shown in FIG. 7, an equalizer (EQ) technology may be applied to the played audio signal through the embodiment shown in FIG. 8, to adjust a specific frequency component in the audio to improve sound quality and listening experience. As shown in FIG. 8, the following steps may be included.

Step 801: determining, based on the noise energy value of each sub-band signal in the noise signal in the first audio signal and an energy value of each sub-band signal in the non-noise signal in the first audio signal, a to-be-adjusted sub-band with a signal-to-noise ratio falling outside the signal-to-noise ratio range in the first audio signal.

The to-be-adjusted sub-band is a sub-band for which audio signal energy needs to be adjusted. For example, when the target playback volume is determined to be −10 dBFS according to the ambient noise information, there may be a case that some sub-bands are −15 dBFS while some sub-bands are −5 dBFS. To reduce a variance of a signal-to-noise ratio of different sub-bands, a signal-to-noise ratio of each sub-band may be determined according to the noise energy value of each sub-band signal in the noise signal and the energy value of each sub-band signal in the non-noise signal in the first audio signal. Then, the to-be-adjusted sub-band is determined according to the signal-to-noise ratio of each sub-band and a signal-to-noise ratio range determined according to the noise signal.

Step 802: adjusting a sub-band signal, in the second audio signal, corresponding to the to-be-adjusted sub-band.

In this embodiment, a method for adjusting the sub-band signal of the to-be-adjusted sub-band may be applying the EQ technology to the second audio signal to respectively adjust amplification amounts for electrical signals with various frequency components. Respectively adjusting different frequencies of the second audio signal may compensate for defects of a loudspeaker and a sound field.

Fine-tuning the to-be-adjusted sub-band may reduce issues of resonance or feedback in the sound in a targeted manner. The EQ may be used for adjusting different frequency components in the audio signal to improve sound quality of the audio signal or create specific sound effects. During the fine-tuning of the to-be-adjusted sub-band by using the EQ technology, EQ parameters corresponding to personalized preferences of a user may be adjusted. The EQ parameters corresponding to the personalized preferences of the user may be preset by the user and prestored in the electronic device.

According to the method provided in the foregoing embodiment of the present disclosure, while determining of the target playback volume and adjusting of the playback volume of the audio through an adaptive gain control technology, some sub-bands of the audio signal to be played may be fine-tuned according to the sub-band signal of the noise signal and the sub-band signal of the non-noise signal, for example, by adding vocal EQ, to further improve playback quality of the audio signal.

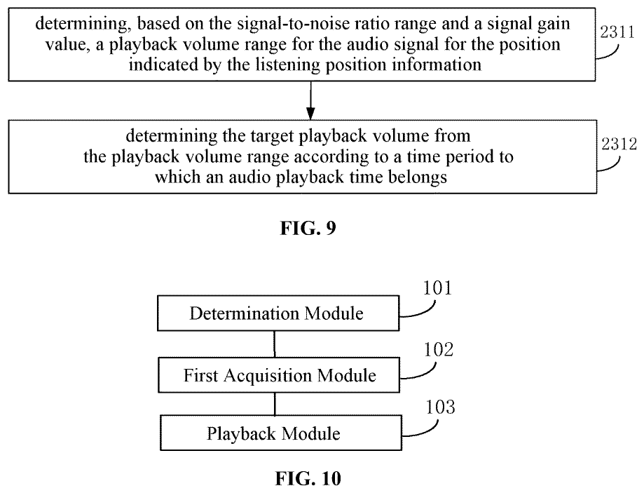

When determining the target playback volume through Step 231 in the embodiment shown in FIG. 7, because the playback volume determined according to the signal-to-noise ratio range is a volume range, any volume may be selected from the volume range as the target playback volume, or the target playback volume may be also determined according to a time period to which an audio playback time belongs. As shown in FIG. 9, based on the embodiment shown in FIG. 7, Step 231 includes the following steps:

Step 2311: determining, based on the signal-to-noise ratio range and the signal gain value, a playback volume range for the audio signal for the position indicated by the listening position information.

The signal-to-noise ratio range is a range that is determined according to the ambient noise information and into which a signal-to-noise ratio for comfortable listening falls. The signal-to-noise ratio range for comfortable listening varies with different noise environments. For example, if noise is 40 dBA, the signal-to-noise ratio range for comfortable listening may be (10 dB, 15 dB). If noise is 60 dBA, the signal-to-noise ratio range for comfortable listening may be (5 dB, 8 dB). The signal gain value is a signal gain value for the position indicated by the listening position information.

As an example, it is assumed that the second audio signal is played in a 1L sound zone. It may be determined, by using a first audio signal acquired from the 1L sound zone, that ambient noise information for the 1L sound zone is En. Based on En and a sound pressure mapping coefficient, a signal-to-noise ratio table may be looked up to obtain an energy range of [S_target_I, S_target_h] of the second audio signal. If the signal gain value determined based on the listening position information is a physical gain g_pos, the energy range of the second audio signal may be determined as [S_target_I, S_target_h]/g_pos.

Step 2312: determining the target playback volume from the playback volume range according to a time period to which an audio playback time belongs.

The audio playback time is a time for playing the second audio signal. In different time periods, a human has different subjective feelings about a volume and strength of a sound heard with the ear. For example, from 8 a.m. to 6 p.m., the human ear requires higher sound strength, while from 0 a.m. to 4 a.m., the human ear requires lower sound strength.

In this embodiment, the time of a day may be divided into a plurality of time periods in advance, and a target playback volume may be determined from the playback volume range according to each time period. For example, if the determined energy range of the second audio signal is [S_target_I, S_target_h]/g_pos, and the playback time falls between 8 a.m. and 6 p.m., the target playback volume may be S_target_h/g_pos. If the playback time falls between 0 a.m. and 4 a.m., the target playback volume may be S_target_I/g_pos. If the playback time falls between 7 p.m. and 10 p.m., the target playback volume may be a value between S_target_I/g_pos and S_target_h/g_pos.

As an example, when a user is traveling in a vehicle in a noisy environment in the morning, if it is determined, according to a noise signal in an audio signal acquired by a microphone in the vehicle, that ambient noise is relatively high, which is, for example, 60 dBA, it is determined, according to ambient noise information and ear position information, that a signal-to-noise ratio range that is relatively comfortable for the user is [8 dB, 12 dB]. In this case, as the current time is morning, the signal-to-noise ratio may be set to 12 dB, to allow the user to better feel the audio signal. When the user is traveling on the road at 11 o'clock at night, if it is determined, according to a noise signal in an audio signal acquired by a microphone in the vehicle, that the ambient noise information is 45 dBA, it is determined, according to the ambient noise information and ear position information, that a signal-to-noise ratio range that is relatively comfortable for the user is [5 dB, 8 dB]. In this case, as the current time is late at night, a signal-to-noise ratio of 5 dB may be selected, to allow the user to be at a volume for comfortable listening and better feel the audio information.

In this example, considering the factor that a human has different subjective feelings about a volume and strength of a sound heard with the ear depending on late at night and the daytime, a volume at which an audio signal is played is more flexibly adjusted. For example, at night, the human ear is more sensitive to sound; in this case, a relatively small volume may be selected within a determined volume range. In this way, user experience is further improved.

According to the method provided in the foregoing embodiment of the present disclosure, a volume may be dynamically adjusted with reference to a time period to which an audio playback time belongs, to ensure comfortable listening experience, thus allowing playback of the audio signal to be more in line with current environment and scenario requirements, with high flexibility, thereby improving user experience in different environments.

### Exemplary Apparatus

FIG. 10 is a schematic diagram illustrating a structure of an audio playback apparatus according to an exemplary embodiment of the present disclosure. As shown in FIG. 10, the apparatus may include:
a determination module 101, configured to determine ambient noise information corresponding to a first audio signal, where the first audio signal is obtained by performing audio acquisition for a target space;
a first acquisition module 102, configured to acquire listening position information for the target space; and
a playback module 103, configured to play, based on the ambient noise information and the listening position information, a second audio signal.

In this embodiment, the first acquisition module 102 may be decomposed and may include a processing module and an image acquisition device. The image acquisition device may be any form of image acquisition sensor such as a camera or a photographic camera, and is applicable to this embodiment as long as such image acquisition sensor may acquire image or video data. The processing module may process the image data acquired by the image acquisition device to obtain the listening position information.

The playback module 103 may be any form of audio playback sensor such as an electronic sound, a loudspeaker, or a reverberator, and is applicable to this embodiment as long as such audio playback sensor may play an audio signal.

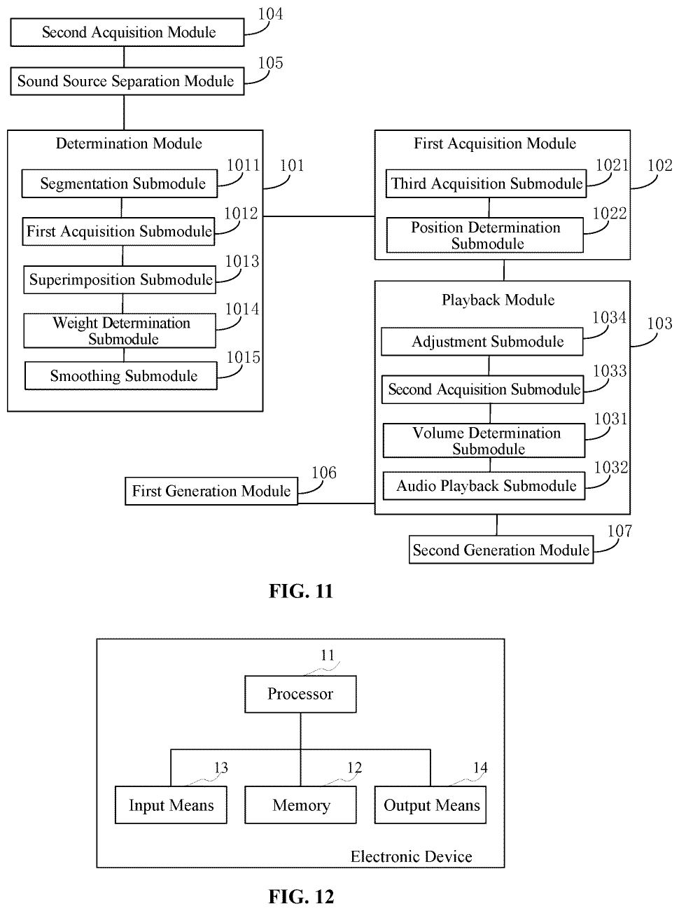

FIG. 11 is a schematic diagram illustrating a structure of an audio playback apparatus according to another exemplary embodiment of the present disclosure. As shown in FIG. 11, based on the embodiment shown in FIG. 10, in some implementations, the apparatus further includes:
a second acquisition module 104, configured to acquire at least one channel of raw audio signal respectively acquired for at least one sound zone within the target space; and
a sound source separation module 105, configured to perform sound source separation and sound source localization on the at least one channel of raw audio signal to obtain at least one channel of first audio signal, where each channel of first audio signal corresponds to one sound zone.

In this embodiment, the second acquisition module 104 may be any form of sound sensor such as a microphone or a microphone array, and is applicable to this embodiment as long as such sound sensor may pick up or acquire an audio signal.

In some implementations, the first audio signal includes a noise signal; and the determination module 101 includes:
a segmentation submodule 1011, configured to segment the noise signal in the first audio signal into a plurality of sub-band signals;
a first acquisition submodule 1012, configured to acquire a noise energy value of each of the plurality of sub-band signals, respectively; and
a superimposition submodule 1013, configured to superimpose the noise energy values of all of the sub-band signals to obtain the ambient noise information corresponding to the first audio signal.

In some implementations, the determination module 101 further includes:
a weight determination submodule 1014, configured to determine, based on the first audio signal, a smoothing weight for the ambient noise information; and
a smoothing submodule 1015, configured to perform, based on the smoothing weight, smoothing process on the ambient noise information corresponding to the first audio signal, and determine smoothed ambient noise information as the ambient noise information corresponding to the first audio signal.

In some implementations, the first audio signal further includes a non-noise signal; and

The weight determination submodule 1014 is specifically configured to determine, based on signal strength of the non-noise signal and signal strength of the noise signal in the first audio signal, the smoothing weight for the ambient noise information.

In some implementations, the playback module 103 includes:
a volume determination submodule 1031, configured to determine, based on the ambient noise information and the listening position information, a target playback volume of an audio signal for a position indicated by the listening position information; and
an audio playback submodule 1032, configured to control, based on the target playback volume, an audio player to play the second audio signal, where the audio player is an audio player corresponding to the position indicated by the listening position information.

In some implementations, the volume determination submodule 1031 is specifically configured to determine a signal-to-noise ratio range matching the ambient noise information from a signal-to-noise ratio table; determine a signal gain value matching the listening position information from a signal gain table; and determine, based on the signal-to-noise ratio range and the signal gain value, the target playback volume of the audio signal for the position indicated by the listening position information.

In some implementations, the playback module 103 further includes:
a second acquisition submodule 1033, configured to determine, based on the noise energy value of each sub-band signal in the noise signal in the first audio signal and an energy value of each sub-band signal in the non-noise signal in the first audio signal, a to-be-adjusted sub-band with a signal-to-noise ratio falling outside the signal-to-noise ratio range in the first audio signal; and
an adjustment submodule 1034, configured to adjust a sub-band signal, in the second audio signal, corresponding to the to-be-adjusted sub-band.

In some implementations, the volume determination submodule 1031 is specifically configured to determine, based on the signal-to-noise ratio range and the signal gain value, a playback volume range for the audio signal for the position indicated by the listening position information; and determine the target playback volume from the playback volume range according to a time period to which an audio playback time belongs.

In some implementations, the apparatus further includes:
a first generation module 106, configured to pre-generate, based on a to-be-tested audio signal played within the target space, the signal gain table, where a signal gain value of at least one position in each of the sound zones is recorded in the signal gain table.

In this embodiment, the first generation module 106 may include an audio playback sensor or a sound sensor. The audio playback sensor may be any form of audio playback sensor such as an electronic sound, a loudspeaker, or a reverberator. The sound sensor may be a sensor configured to acquire an audio signal, such as a microphone or a microphone array.

In some implementations, the volume determination submodule 1031 is specifically configured to determine, based on a sound pressure mapping coefficient of each microphone, a physical sound pressure corresponding to the ambient noise information; and acquire a signal-to-noise ratio range matching the physical sound pressure from the signal-to-noise ratio table.

In some implementations, the apparatus further includes:
a second generation module 107, configured to pre-generate, based on a to-be-tested audio signal played within the target space, the signal-to-noise ratio table, where a signal-to-noise ratio range corresponding to at least one physical sound pressure is recorded in the signal-to-noise ratio table.

In some implementations, the first acquisition module 102 includes:
a third acquisition submodule 1021, configured to acquire an image or a video acquired for the target space; and
a position determination submodule 1022, configured to determine, based on the image or the video, ear position information of a user for each of the sound zones in the target space.

It should be noted that, the modules in this apparatus may be decomposed and/or recombined. These decompositions and/or recombinations should be considered as equivalent solutions of this apparatus.

The exemplary embodiment of this apparatus partially corresponds to the exemplary method section described above, and relevant contents may be referenced and quoted to each other. For beneficial technical effects corresponding to the exemplary embodiment of this apparatus, refer to the corresponding beneficial technical effects of the exemplary method section described above, which are not repeated herein.

### Exemplary Electronic Device

FIG. 12 is a structural diagram of an electronic device according to an embodiment of the present disclosure. The electronic device includes at least one processor 11 and a memory 12.

The processor 11 may be a central processing unit (CPU) or another form of processing unit having a data processing capability and/or an instruction execution capability, and may control another component in the electronic device to perform a desired function.

The memory 12 may include one or more computer program products. The computer program product may include various forms of computer readable storage mediums, such as a volatile memory and/or a non-volatile memory. The volatile memory may include, for example, a random access memory (RAM) and/or a cache. The non-volatile memory may include, for example, a read-only memory (ROM), a hard disk, or a flash memory. The computer readable storage medium may store one or more computer program instructions. The processor 11 may run the one or more computer program instructions to implement the audio playback method and/or other desired functions in the foregoing embodiments of the present disclosure.

In an example, the electronic device may further include: an input means 13 and an output means 14. The components are interconnected through a bus system and/or other forms of connection mechanisms (not shown).

The input means 13 may further include, for example, a keyboard, a mouse, a touchscreen, or a sound pickup device (such as a microphone array).

The output means 14 may output various information to the outside, and may include, for example, a display, a loudspeaker, a printer, and a communication network and a remote output means connected thereto.

Certainly, for simplicity, only some components in the electronic device that are related to the present disclosure are shown in FIG. 12, and components such as a bus and an input/output interface are omitted. Besides, the electronic device may further include any other appropriate components depending on specific applications.

### Exemplary Computer Program Product and Computer Readable Storage Medium

In addition to the foregoing method and device, the embodiments of the present disclosure may also be a computer program product, which includes computer program instructions that, when run by a processor, cause the processor to perform the steps of the audio playback method according to the embodiments of the present disclosure that is described in the “exemplary method” section of this specification.

The computer program product may be program code, written with one or any combination of a plurality of programming languages, that is configured to perform the operations in the embodiments of the present disclosure. The programming languages include an object-oriented programming language such as Java or C++, and further include a conventional procedural programming language such as a “C” language or a similar programming language. The program code may be entirely or partially executed on a user computing device, executed as an independent software package, partially executed on the user computing device and partially executed on a remote computing device, or entirely executed on the remote computing device or a server.

In addition, the embodiments of the present disclosure may further relate to a computer readable storage medium, on which computer program instructions are stored. The computer program instructions, when run by a processor, cause the processor to perform the steps of the audio playback method according to the embodiments of the present disclosure that is described in the “exemplary method” section of this specification.

The computer readable storage medium may be one readable medium or any combination of a plurality of readable media. The readable medium may be a readable signal medium or a readable storage medium. The readable storage medium may include, for example, but is not limited to electrical, magnetic, optical, electromagnetic, infrared, or semiconductor systems, apparatuses, or devices, or any combination of the above. More specific examples (a non-exhaustive list) of the readable storage medium include: an electrical connection with one or more conducting wires, a portable disk, a hard disk, a RAM, a ROM, an EPROM or a flash memory, an optical fiber, a portable compact disk ROM (CD-ROM), an optical storage device, a magnetic storage device, or any suitable combination of the above.

Basic principles of the present disclosure are described above in combination with specific embodiments. However, it should be pointed out that the advantages, superiorities, effects, and the like mentioned in the present disclosure are merely examples rather than limitations, and it should not be considered that these advantages, superiorities, effects, and the like are necessary for each of the embodiments of the present disclosure. In addition, specific details described above are merely for examples and for ease of understanding, rather than limitations. The details described above do not limit that the present disclosure must be implemented by using the foregoing specific details.

A person skilled in the art may make various modifications and variations to the present disclosure without departing from the spirit and scope of this application. The present disclosure is intended to cover these modifications and variations provided that they fall within the scope of protection defined by the claims of the present disclosure or equivalents thereof.

What is claimed is:

1. An audio playback method, comprising:
determining ambient noise information corresponding to a first audio signal, wherein the first audio signal is obtained by performing audio acquisition for a target space;
acquiring listening position information for the target space; and
playing, based on the ambient noise information and the listening position information, a second audio signal.

2. The method according to claim 1, wherein before the determining ambient noise information corresponding to a first audio signal, the method further comprises:
acquiring at least one channel of raw audio signal respectively acquired for at least one sound zone within the target space; and
performing sound source separation and sound source localization on the at least one channel of raw audio signal to obtain at least one channel of first audio signal, wherein each channel of first audio signal corresponds to one sound zone.

3. The method according to claim 1, wherein the first audio signal comprises a noise signal; and
the determining ambient noise information corresponding to a first audio signal comprises:
segmenting a noise signal in the first audio signal into a plurality of sub-band signals;
acquiring a noise energy value of each of the plurality of sub-band signals, respectively; and
superimposing the noise energy values of all of the sub-band signals to obtain the ambient noise information corresponding to the first audio signal.

4. The method according to claim 3, wherein after the determining ambient noise information corresponding to the first audio signal, the method further comprises:
determining, based on the first audio signal, a smoothing weight for the ambient noise information; and
performing, based on the smoothing weight, smoothing process on the ambient noise information corresponding to the first audio signal, and determining the smoothed ambient noise information as the ambient noise information corresponding to the first audio signal.

5. The method according to claim 4, wherein the first audio signal further comprises a non-noise signal; and
the determining, based on the first audio signal, a smoothing weight for the ambient noise information comprises:
determining, based on signal strength of the non-noise signal and signal strength of the noise signal in the first audio signal, the smoothing weight for the ambient noise information.

6. The method according to claim 4, wherein the playing, based on the ambient noise information and the listening position information, a second audio signal comprises:
determining, based on the ambient noise information and the listening position information, a target playback volume for the audio signal for a position indicated by the listening position information; and
controlling, based on the target playback volume, an audio player to play the second audio signal, the audio player being an audio player corresponding to the position indicated by the listening position information.

7. The method according to claim 6, wherein the determining, based on the ambient noise information and the listening position information, a target playback volume for an audio signal for a position indicated by the listening position information comprises:
determining a signal-to-noise ratio range matching the ambient noise information from a signal-to-noise ratio table;
determining a signal gain value matching the listening position information from a signal gain table; and
determining, based on the signal-to-noise ratio range and the signal gain value, the target playback volume of the audio signal for the position indicated by the listening position information.

8. The method according to claim 7, wherein after the determining the target playback volume of an audio signal for a position indicated by the listening position information, and before the controlling, based on the target playback volume, an audio player to play the second audio signal, the method further comprises:
determining, based on the noise energy value of each sub-band signal in the noise signal in the first audio signal and an energy value of each sub-band signal in the non-noise signal in the first audio signal, a to-be-adjusted sub-band with a signal-to-noise ratio falling outside the signal-to-noise ratio range in the first audio signal; and
adjusting a sub-band signal, in the second audio signal, corresponding to the to-be-adjusted sub-band.

9. The method according to claim 7, wherein the determining, based on the signal-to-noise ratio range and the signal gain value, the target playback volume for the audio signal for the position indicated by the listening position information comprises:
determining, based on the signal-to-noise ratio range and the signal gain value, a playback volume range for the audio signal for the position indicated by the listening position information; and
determining the target playback volume from the playback volume range according to a time period to which the audio playback time belongs.

10. The method according to claim 7, further comprising:
pre-generating, based on a to-be-tested audio signal played within the target space, the signal gain table, wherein a signal gain value of at least one position in each of the sound zones is recorded in the signal gain table.

11. The method according to claim 7, wherein the determining a signal-to-noise ratio range matching the ambient noise information from a signal-to-noise ratio table comprises:
determining, based on a sound pressure mapping coefficient of each microphone, a physical sound pressure corresponding to the ambient noise information; and
determining a signal-to-noise ratio range matching the physical sound pressure from the signal-to-noise ratio table.

12. The method according to claim 9, further comprising:
pre-generating, based on a to-be-tested audio signal played within the target space, the signal-to-noise ratio table, wherein a signal-to-noise ratio range corresponding to at least one physical sound pressure is recorded in the signal-to-noise ratio table.

13. The method according to claim 1, wherein the acquiring listening position information for the target space comprises:
acquiring an image or a video acquired for the target space; and
determining, based on the image or the video, ear position information of a user for each of the sound zones within the target space.

14. The method according to claim 2, wherein the first audio signal comprises a noise signal; and
the determining ambient noise information corresponding to a first audio signal comprises:
segmenting a noise signal in the first audio signal into a plurality of sub-band signals;
acquiring a noise energy value of each of the plurality of sub-band signals, respectively; and
superimposing the noise energy values of all of the sub-band signals to obtain the ambient noise information corresponding to the first audio signal.

15. A non-transitory computer readable storage medium, on which a computer program is stored, wherein the computer program, when executed by a processor, causes the processor to implement an audio playback method comprising:
determining ambient noise information corresponding to a first audio signal, wherein the first audio signal is obtained by performing audio acquisition for a target space;
acquiring listening position information for the target space; and
playing, based on the ambient noise information and the listening position information, a second audio signal.

16. An electronic device, comprising:
a processor; and
a memory, configured to store instructions executable by the processor, wherein the processor is configured to read the executable instructions from the memory and execute the instructions to implement an audio playback method comprising:
determining ambient noise information corresponding to a first audio signal, wherein the first audio signal is obtained by performing audio acquisition for a target space;
acquiring listening position information for the target space; and
playing, based on the ambient noise information and the listening position information, a second audio signal.

17. The electronic device according to claim 16, wherein before the determining ambient noise information corresponding to a first audio signal, the method further comprises:
acquiring at least one channel of raw audio signal respectively acquired for at least one sound zone within the target space; and
performing sound source separation and sound source localization on the at least one channel of raw audio signal to obtain at least one channel of first audio signal, wherein each channel of first audio signal corresponds to one sound zone.

18. The electronic device according to claim 16, wherein the first audio signal comprises a noise signal; and
the determining ambient noise information corresponding to a first audio signal comprises:
segmenting a noise signal in the first audio signal into a plurality of sub-band signals;
acquiring a noise energy value of each of the plurality of sub-band signals, respectively; and
superimposing the noise energy values of all of the sub-band signals to obtain the ambient noise information corresponding to the first audio signal.

19. The electronic device according to claim 18, wherein after the determining ambient noise information corresponding to the first audio signal, the method further comprises:
determining, based on the first audio signal, a smoothing weight for the ambient noise information; and
performing, based on the smoothing weight, smoothing process on the ambient noise information corresponding to the first audio signal, and determining the smoothed ambient noise information as the ambient noise information corresponding to the first audio signal.

20. The electronic device according to claim 19, wherein the first audio signal further comprises a non-noise signal; and
the determining, based on the first audio signal, a smoothing weight for the ambient noise information comprises:
determining, based on signal strength of the non-noise signal and signal strength of the noise signal in the first audio signal, the smoothing weight for the ambient noise information.
